(19) United States
(12) Patent Application Publication
(10) Pub. No.: US 2022/0162896 A1
(43) Pub. Date: May 26, 2022

(54) DRIVING DEVICE FOR DOOR OPENING AND CLOSING

(71) Applicant: Guangdong Niuniu Intelligent space Technology Co., Ltd, Zhaoqing (CN)

(72) Inventor: Cheung Choi CHAN, Zhaoqing (CN)

(21) Appl. No.: 17/194,088

(22) Filed: Mar. 5, 2021

(30) Foreign Application Priority Data
Nov. 20, 2020 (CN) 202011308734.8

(51) Int. Cl. E05F 15/614

(52) U.S. Cl. CPC E05F 15/614

(57) ABSTRACT

The disclosure discloses a driving device for door opening and closing, which includes: a box body; a permanent magnet synchronous motor arranged inside the box body, an output shaft of the permanent magnet synchronous motor extending along a vertical direction; and a gear set arranged inside the box body and connected with the output shaft of the permanent magnet synchronous motor, and a gear at a tail end of the gear set is provided with a connecting rotating shaft that extends along a vertical direction and is used for connecting a door panel. The above driving device for door opening and closing uses the permanent magnet synchronous motor as a driving source, which is matched with the gear set to implement transmission, the door panel is driven to rotate by the connecting rotating shaft on the gear at the tail end of the gear set.

### RELATED APPLICATION

This application claims the priority benefit of Chinese Pat. App. No. 202011308734.8, filed on Nov. 20, 2020, which is fully incorporated by reference herein in its entirety.

### TECHNICAL FIELD

The present disclosure relates to a driving device for door opening and closing.

### BACKGROUND

In the prior art, a general driving device for door opening and closing includes a box body, a motor built in the box body and a transmission pair connected with an output shaft of the motor. Due to limitation of an installation space, in order to avoid an excessive height of the box body, the driving device for door opening and closing that employs a common motor needs to arrange the output shaft of the motor in a horizontal manner, and uses a worm gear as the transmission pair, so that an output end of the driving device for door opening and closing is switched to a vertical direction, thus connecting a door panel and driving the door panel to rotate relative to a door frame.

The driving device for door opening and closing with the above structure is large in volume, which is difficult to adapt to a situation of a narrow installation space. Moreover, in the case of power failure, it is difficult to manually open a door due to a self-locking angle of the worm gear, thus causing troubles for users.

### SUMMARY

The present disclosure aims to solve at least one of the technical problems in the prior art. For this purpose, the present disclosure provides a driving device for door opening and closing, which is small in volume and can be manually switched on or off after power failure.

A driving device for door opening and closing according to an embodiment of the present disclosure includes: a box body; a permanent magnet synchronous motor arranged inside the box body, an output shaft of the permanent magnet synchronous motor extending along a vertical direction; and a gear set arranged inside the box body and connected with the output shaft of the permanent magnet synchronous motor, and a gear at a tail end of the gear set is provided with a connecting rotating shaft that extends along a vertical direction and is used for connecting a door panel.

The driving device for door opening and closing according to the embodiment of the present disclosure has at least the following beneficial effects.

The above driving device for door opening and closing uses the permanent magnet synchronous motor as a driving source, which is matched with the gear set to implement transmission, the door panel is driven to rotate by the connecting rotating shaft on the gear at the tail end of the gear set, since the permanent magnet synchronous motor has a characteristic of a small axial size, the output shaft of the permanent magnet synchronous motor is arranged in a vertically upward manner and matched with the gear set to implement transmission, and then the output shaft does not need to be arranged in a horizontal manner and matched with a worm gear to implement transmission, so that the driving device for door opening and closing is smaller in size, and the door panel can be manually opened in a power failure state, without jamming.

In some embodiments of the present disclosure, the permanent magnet synchronous motor is connected with a controller for controlling a rotation angle and a rotation rate thereof.

In some embodiments of the present disclosure, the box body is arranged in an upper beam of a door frame, and the connecting rotating shaft downwardly penetrates through the upper beam of the door frame and is connected with an upper cross beam of the door panel.

In some embodiments of the present disclosure, the driving device for door opening and closing further includes a door closing positioning mechanism connected between a lower cross beam of the door panel and the ground.

In some embodiments of the present disclosure, the door closing positioning mechanism includes a positioning rod and an elastic positioning member, the positioning rod is provided with a positioning groove, the elastic positioning member is provided with a positioning part matched with the positioning groove, and the elastic positioning member is capable of rotating relative to the positioning rod, so that the positioning part enters and exits the positioning groove.

In some embodiments of the present disclosure, the positioning rod is fixedly arranged on the ground and extends upwardly, a cylindrical part is arranged on a side surface of the positioning rod, the side surface of the cylindrical part is recessed to form the positioning groove, the elastic positioning member includes a fixed seat arranged on the lower cross beam of the door panel, the fixed seat is connected with a movable seat through an elastic member, the positioning part is a rolling wheel rotatably arranged on the movable seat, and the rolling wheel is capable of elastically abutting against the cylindrical part or the positioning groove.

In some embodiments of the present disclosure, the door closing positioning mechanism includes an installation box built in the lower cross beam of the door panel, the elastic positioning member and the cylindrical part of the positioning rod are both arranged in the installation box, and a through hole for the positioning rod to downwardly penetrate through is arranged in a bottom surface of the installation box.

In some embodiments of the present disclosure, a cross section of a lower part of the connecting rotating shaft is rectangular, the lower part of the connecting rotating shaft is connected with an anti-rotation connecting assembly, and the anti-rotation connecting assembly is fixedly connected with the door panel.

In some embodiments of the present disclosure, the anti-rotation connecting assembly includes a fixed connecting seat fixedly connected with the door panel, the fixed connecting seat is provided with an opening groove with an opening in a side surface, a connecting block for closing the opening of the opening groove is detachably installed on the fixed connecting seat, and the connecting block and the opening groove jointly enclose an anti-rotation groove matched with a contour shape of the lower part of the connecting rotating shaft.

In some embodiments of the present disclosure, two ends of the box body are respectively connected with an installation panel for fixing on an inner wall of the upper beam of the door frame.

The additional aspects and advantages of the present disclosure will be partially provided in the following description, and will partially be apparent in the following description, or learned by practice of the present disclosure.

### BRIEF DESCRIPTION OF THE DRAWINGS

The above and/or additional aspects and advantages of the present disclosure will be apparent and easily understood from the description of the embodiments with reference to the following accompanying drawings, wherein:

FIG. 1 is a schematic structure diagram of an embodiment of a driving device for door opening and closing applied to a door panel and a door frame according to the present disclosure;

FIG. 2 is an exploded structure diagram of an embodiment of the driving device for door opening and closing according to the embodiment in FIG. 1;

FIG. 3 is a schematic appearance diagram of an embodiment of a door closing positioning mechanism according to the embodiment in FIG. 1; and

FIG. 4 is an exploded structure diagram of the embodiment in FIG. 3.

### DETAILED DESCRIPTION

The embodiments of the present disclosure are described in detail hereinafter. Examples of the embodiments are shown in the accompanying drawings. The same or similar reference numerals throughout the accompanying drawings denote the same or similar elements or elements having the same or similar functions. The embodiments described hereinafter with reference to the accompanying drawings are exemplary and are only used to explain the present disclosure, but shall not be understood as limiting the present disclosure.

In the description of the present disclosure, it shall be understood that the orientation or position relationship indicated by the terms “up”, “down”, “front”, “rear”, “left”, “right”, “vertical”, “horizontal”, “top”, “bottom”, “inside”, “outside”, and the like is based on the orientation or position relationship shown in the accompanying drawings, it is only for the convenience of description of the present disclosure and simplification of the description, and it is not to indicate or imply that the indicated device or element must have a specific orientation, and be constructed and operated in a specific orientation. Therefore, the terms shall not be understood as limiting the present disclosure.

In the description of the present disclosure, the meaning of several refers to be one or more, and the meaning of multiple refers to be more than two. The meanings of greater than, less than, more than, and the like are understood as not including this number, while the meanings of above, below, within, and the like are understood as including this number. If the terms first and second are used for the purpose of distinguishing the technical features only in the description, and cannot be understood as indicating or implying relative importance, implicitly indicating the number of technical features indicated thereby, or implicitly indicating the order of technical features indicated thereby.

In the description of the present disclosure, it shall be noted that the terms “installation”, “connected” and “connection” if any shall be understood in a broad sense unless otherwise specified and defined. For example, they can be fixed connection, removable connection or integrated connection; can be mechanical connection or electrical connection; and can be direct connection, or indirect connection through an intermediate medium, and connection inside two elements. The specific meanings of the above terms in the present disclosure can be understood in a specific case by those of ordinary skills in the art.

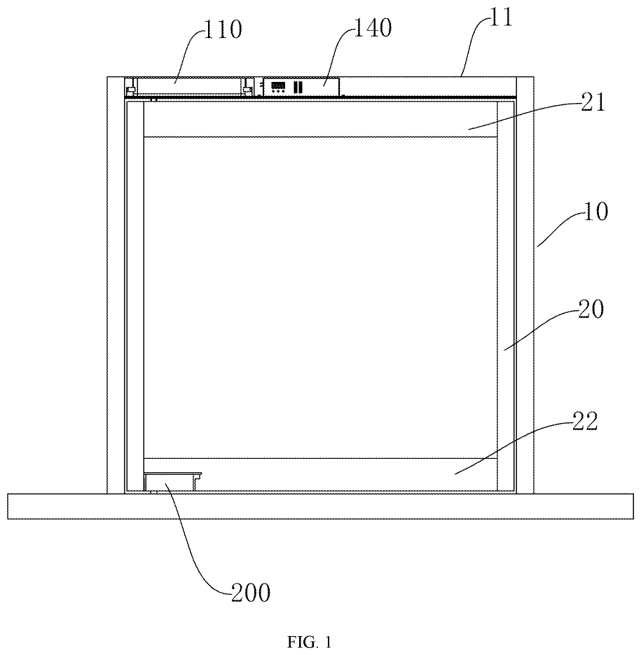

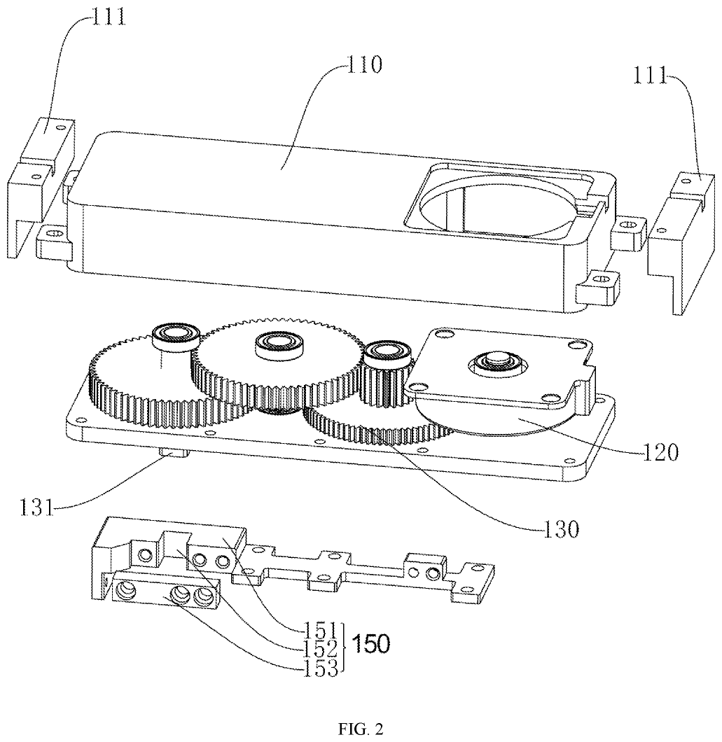

With reference to FIG. 1 and FIG. 2, the present disclosure discloses a driving device for door opening and closing, which includes: a box body 110; a permanent magnet synchronous motor 120 arranged inside the box body 110, an output shaft of the permanent magnet synchronous motor 120 extending along a vertical direction; and a gear set 130 arranged inside the box body 110 and connected with the output shaft of the permanent magnet synchronous motor 120. A gear at a tail end of the gear set 130 is provided with a connecting rotating shaft 131 that extends along a vertical direction and is used for connecting a door panel 20. The above driving device for door opening and closing uses the permanent magnet synchronous motor 120 as a driving source, which is matched with the gear set 130 to implement transmission, and the door panel 20 is driven to rotate by the connecting rotating shaft 131 on the gear at the tail end of the gear set 130. Since the permanent magnet synchronous motor 120 has a characteristic of a small axial size, the output shaft of the permanent magnet synchronous motor 120 is arranged in a vertically upward manner and matched with the gear set 130 to implement transmission, and then the output shaft does not need to be arranged in a horizontal manner and matched with a worm gear to implement transmission, so that the driving device for door opening and closing is smaller in size, and the door panel 20 can be manually opened in a power failure state, without jamming. In addition, since a rotor excitation mode is used in the permanent magnet synchronous motor 120, the permanent magnet synchronous motor has a larger output torque compared with a traditional motor, thus being capable of implementing characteristics of a low rotating speed and a large torque.

With reference to FIG. 1, in some embodiments of the present disclosure, the permanent magnet synchronous motor 120 is connected with a controller 140 for controlling a rotation angle and a rotation rate thereof. An angle of opening or closing the door panel 20 can be controlled by controlling the rotation angle of the permanent magnet synchronous motor 120 through the controller 140, and a speed of opening or closing the door panel 20 can be controlled by controlling the rotation rate of the permanent magnet synchronous motor 120 through the controller 140. Generally, when the controller 140 controls the door panel 20 to open, the permanent magnet synchronous motor 120 is rotated slowly first, at the moment, the door panel 20 is opened slowly, and then the permanent magnet synchronous motor 120 is rotated at an accelerated speed. In the process, the door panel 20 is opened quickly. When the door panel 20 is opened near a set angle, the controller 140 controls the permanent magnet synchronous motor 120 to rotate slowly, and the door panel 20 is opened slowly to a set angle position. Similarly, when the controller 140 controls the door panel 20 to close, the permanent magnet synchronous motor 120 is rotated slowly first, at the moment, the door panel 20 is closed slowly, and then the permanent magnet synchronous motor 120 is rotated at an accelerated speed. In the process, a closing speed of the door panel 20 is accelerated, when the door panel 20 is closed near a set position, the controller 140 controls the permanent magnet synchronous motor 120 to rotate slowly, and the door panel 20 is closed slowly to the set position.

With reference to FIG. 2, in some embodiments of the present disclosure, the box body 110 is arranged in an upper beam 11 of a door frame 10, so that components and parts in the box body 110 are capable of being protected while achieving an aesthetic effect. The connecting rotating shaft 131 downwardly penetrates through the upper beam 11 of the door frame 10 and is connected with an upper cross beam 21 of the door panel 20. The connecting rotating shaft 131 serves as a pivot shaft between the door panel 20 and the door frame 10.

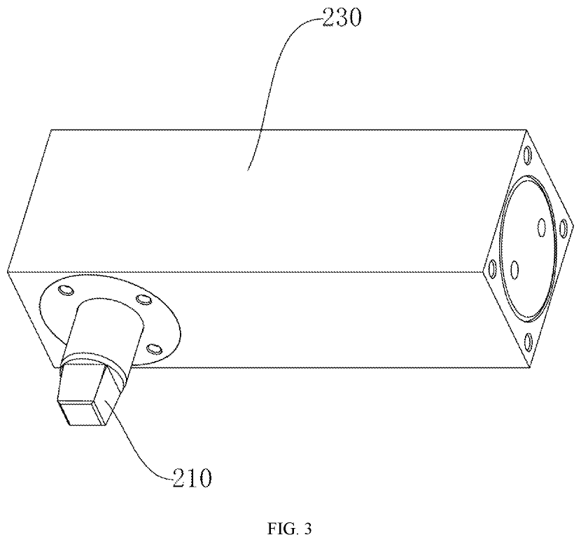

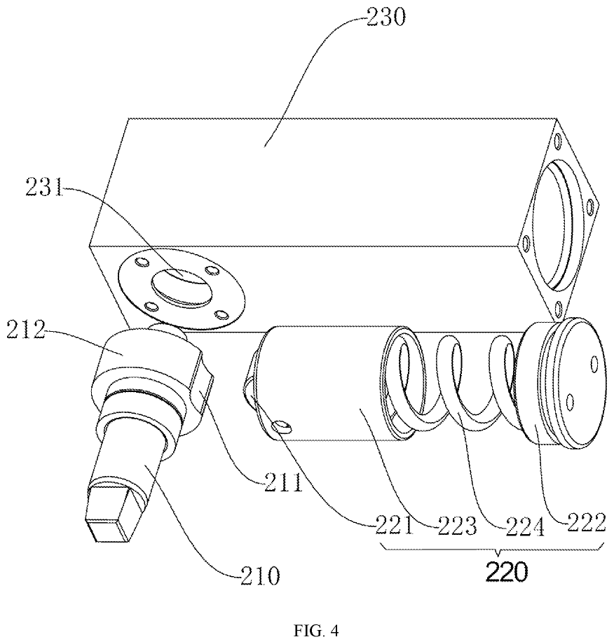

With reference to FIG. 1, FIG. 3, and FIG. 4, in order to keep the door panel 20 stable after closing and reduce wear on the gear set 130, the driving device for door opening and closing further includes a door closing positioning mechanism 200 connected between a lower cross beam 22 of the door panel 20 and the ground.

In some embodiments of the present disclosure, the door closing positioning mechanism 200 includes a positioning rod 210 and an elastic positioning member 220, the positioning rod 210 is provided with a positioning groove 211, the elastic positioning member 220 is provided with a positioning part 221 matched with the positioning groove 211, and the elastic positioning member 220 is capable of rotating relative to the positioning rod 210, so that the positioning part 221 enters and exits the positioning groove 210. One of the positioning rod 210 and the elastic positioning member 220 is arranged on the door panel 20, and the other is arranged on the ground. Certainly, in other embodiments, the door closing positioning mechanism 200 can also be replaced by the following technical solution: a positioning hole is arranged in a bottom of the door panel 20, a sunken groove is arranged in the ground, a telescopic positioning pin is arranged in the sunken groove, and the positioning pin is inserted into the positioning hole to implement positioning of the door panel 20 after door closing.

With reference to FIG. 4, in some embodiments of the present disclosure, the positioning rod 210 is fixedly arranged on the ground and extends upwardly, a cylindrical part 212 is arranged on a side surface of the positioning rod 210, and the side surface of the cylindrical part 212 is recessed to form the positioning groove 211. The elastic positioning member 220 includes a fixed seat 222 arranged on the lower cross beam 22 of the door panel 20, and the fixed seat 222 is connected with a movable seat 223 through an elastic member 224. The positioning part 221 is a rolling wheel rotatably arranged on the movable seat 223, and the rolling wheel is capable of elastically abutting against the cylindrical part 212 or the positioning groove 211. In the embodiment, the elastic member 224 is a compression spring, and the compression spring drives the rolling wheel on the movable seat 223 to move towards the cylindrical part 212. When the door panel 20 is in a closed state, the positioning groove 211 faces the rolling wheel to implement positioning. During a closing process of the door panel 20, the rolling wheel abuts against the cylindrical part 212 and moves around a circumferential side wall of the cylindrical part 212 until the door panel 20 is closed in place, and the rolling wheel enters the positioning groove 211.

With reference to FIG. 3 and FIG. 4, in some embodiments of the present disclosure, in order to reduce an erosion probability of the components and parts of the door closing positioning mechanism 200, the door closing positioning mechanism 200 includes an installation box 230 built in the lower cross beam 22 of the door panel 20, the elastic positioning member 220 and the cylindrical part 212 of the positioning rod 210 are both arranged in the installation box 230, and a through hole 231 for the positioning rod 210 to downwardly penetrate through is arranged in a bottom surface of the installation box 230.

With reference to FIG. 2, in some embodiments of the present disclosure, a cross section of a lower part of the connecting rotating shaft 131 is rectangular, the lower part of the connecting rotating shaft 131 is connected with an anti-rotation connecting assembly 150, and the anti-rotation connecting assembly 150 is fixedly connected with the door panel 20. When the door panel 20 is rotated relative to the door frame 10, the anti-rotation connecting assembly 150 is relatively fixed with the connecting rotating shaft 131, thus improving a moving stability of the door panel 20 driven by the driving device for door opening and closing.

With reference to FIG. 2, in some embodiments of the present disclosure, the anti-rotation connecting assembly 150 includes a fixed connecting seat 151 fixedly connected with the door panel 20, the fixed connecting seat 151 is provided with an opening groove 152 with an opening in a side surface, a connecting block 153 for closing the opening of the opening groove 152 is detachably installed on the fixed connecting seat 151, and the connecting block 153 and the opening groove 152 jointly enclose an anti-rotation groove matched with a contour shape of the lower part of the connecting rotating shaft 131, which means that the anti-rotation groove is also rectangular. The anti-rotation connecting assembly 150 with the above structure is beneficial for installation and disassembly of the connecting rotating shaft 131. In the embodiment, the connecting block 153 and the fixed connecting seat 151 are fastened through a screw.

In some embodiments of the present disclosure, in order to facilitate installation and fixation of the box body 110, two ends of the box body 110 are respectively connected with an installation panel 111 for fixing on an inner wall of the upper beam 11 of the door frame 10. The installation panel 111 and the upper beam 11 of the door frame 10 can be fixed by welding, the two ends of the box body 110 are respectively provided with a side ear, the side ear is provided with a threaded through hole, and the side ear is connected with the installation panel 111 through a threaded fastener.

Various technical features of the above embodiments can be combined randomly, and in order to make the description concise, possible combinations of various technical features in the above embodiments are not all described. However, as long as the combinations of these technical features have no contradiction, the combinations of these technical features shall be considered as falling into the scope recorded by the description.

Although the embodiments of the present disclosure have been shown and described, those of ordinary skills in the art can understand that various changes, modifications, substitutions and variations can be made to these embodiments without departing from the principle and purpose of the present disclosure, and the scope of the present disclosure is defined by the claims and their equivalents.

1. A driving device for door opening and closing, comprising:
a box body;
a permanent magnet synchronous motor arranged inside the box body, wherein an output shaft of the permanent magnet synchronous motor extends along a vertical direction; and
a gear set arranged inside the box body and connected with the output shaft of the permanent magnet synchronous motor,
wherein a gear at a tail end of the gear set is provided with a connecting rotating shaft that extends along a vertical direction and used for connecting a door panel.

2. The driving device for door opening and closing according to claim 1, wherein:
the permanent magnet synchronous motor is connected with a controller for controlling a rotation angle and a rotation rate thereof.

3. The driving device for door opening and closing according to claim 1, wherein:
the box body is arranged in an upper beam of a door frame, and the connecting rotating shaft downwardly penetrates through the upper beam of the door frame and is connected with an upper cross beam of the door panel.

4. The driving device for door opening and closing according to claim 1, wherein:
the driving device for door opening and closing further comprises a door closing positioning mechanism connected between a lower cross beam of the door panel and the ground.

5. The driving device for door opening and closing according to claim 3, wherein:
the driving device for door opening and closing further comprises a door closing positioning mechanism connected between a lower cross beam of the door panel and the ground.

6. The driving device for door opening and closing according to claim 4, wherein:
the door closing positioning mechanism comprises a positioning rod and an elastic positioning member, the positioning rod is provided with a positioning groove, the elastic positioning member is provided with a positioning part matched with the positioning groove, and the elastic positioning member is capable of rotating relative to the positioning rod, so that the positioning part enters and exits the positioning groove.

7. The driving device for door opening and closing according to claim 6, wherein:
the positioning rod is fixedly arranged on the ground and extends upwardly, a cylindrical part is arranged on a side surface of the positioning rod, a side surface of the cylindrical part is recessed to form the positioning groove, the elastic positioning member comprises a fixed seat arranged on the lower cross beam of the door panel, the fixed seat is connected with a movable seat through an elastic member, the positioning part is a rolling wheel rotatably arranged on the movable seat, and the rolling wheel is capable of elastically abutting against the cylindrical part or the positioning groove.

8. The driving device for door opening and closing according to claim 6, wherein:
the door closing positioning mechanism comprises an installation box built in the lower cross beam of the door panel, the elastic positioning member and the cylindrical part of the positioning rod are both arranged in the installation box, and a through hole for the positioning rod to downwardly penetrate through is arranged in a bottom surface of the installation box.

9. The driving device for door opening and closing according to claim 3, wherein:
a cross section of a lower part of the connecting rotating shaft is rectangular, the lower part of the connecting rotating shaft is connected with an anti-rotation connecting assembly, and the anti-rotation connecting assembly is fixedly connected with the door panel.

10. The driving device for door opening and closing according to claim 9, wherein:
the anti-rotation connecting assembly comprises a fixed connecting seat fixedly connected with the door panel, the fixed connecting seat is provided with an opening groove with an opening in a side surface, a connecting block for closing the opening of the opening groove is detachably installed on the fixed connecting seat, and the connecting block and the opening groove jointly enclose an anti-rotation groove matched with a contour shape of the lower part of the connecting rotating shaft.

11. The driving device for door opening and closing according to claim 3, wherein:
two ends of the box body are respectively connected with an installation panel for fixing on an inner wall of the upper beam of the door frame.
